(19) United States
(12) Patent Application Publication
(10) Pub. No.: US 2008/0028213 A1
(43) Pub. Date: Jan. 31, 2008

(54) Apparatus and system for improving computer system security

(76) Inventor: Michael Hall, Santa Cruz, CA (US)

Correspondence Address: WAGNER, MURABITO & HAO LLP, Third Floor, Two North Market Street, San Jose, CA, 95113, US

(21) Appl. No.: 11/497,471

(22) Filed: Jul. 31, 2006

(51) Int. Cl. H04L 9/00

(52) U.S. Cl. 713/165

(57) ABSTRACT

An apparatus and system for improving computer system security. In one embodiment, an apparatus for improving security includes a housing with a surface for use with a cursor positioning device for a computer system. The apparatus also includes a first member for placing a second object thereon, where the first member is operable for insertion into the housing. A lock mechanism is coupled with the housing, where the lock mechanism is operable to place the first member in a secured state by limiting movement thereof, and where the secured state limits access to the second object. The apparatus may also include a second member coupled to the housing for securing the apparatus to a third object.

### BACKGROUND OF THE INVENTION

While computer security has always been a concern, the increased use of computers and computer-implemented systems over the past decade has brought with it new and more complex security issues. The average person now uses the computer to do business, manage investment and banking activities, pursue hobbies, and even communicate with friends and family. As such, more and more confidential information is being entered into computers, which may be accessed by unauthorized users. For example, passwords and usernames used to access the confidential information are often kept and organized in hard-copy form, which exacerbates the existing computer-related security issues given the inconvenience and difficulty of keeping such information handy yet secure.

The most common solution to securing confidential information in hard-copy form includes the use of notepads to record passwords and usernames. Although this may provide means of organizing confidential information, it lacks security provisions. As such, means to hide or otherwise prevent viewing of the confidential information only make accessing the information more difficult, and in some cases, impossible. For example, an attempt to keep a list of passwords on one's person at all times will eventually fail, and therefore, inevitably leave one without access to the many necessities that computers and the Internet provide. Moreover, loss or even misplacement of the list may lead to further hassles and security breaches giving unauthorized users an open invitation to access any and all confidential information derived from the listed data.

Additionally, computers are used to store many types of data which are not password protected. For example, the computer system of an average user may contain spreadsheets tracking investments, confidential business files, password/username listings, etc. As such, computer manufacturers and developers have implemented several software and hardware mechanisms which do little more than provide a false sense of security. For example, a user may lock the operating system such that a password is required to resume use of the system. However, such passwords are often circulated among co-workers (e.g., IT departments) and family members, or stored in hard-copy as discussed above. Additionally, some computer system chassis contain locking doors, but such doors merely prevent unauthorized de-powering of the machine. As such, an unauthorized user may surpass conventional software and hardware security measures with little effort, thereby gaining access to confidential information and other functionality of the system. Moreover, in addition to doing little to increase security, such measures make using the computer system more inconvenient.

Given the downsides of conventional security measures, users have begun to use portable storage media to store confidential information in soft-copy form. For example, secure passwords, usernames and documents may be placed on a portable memory device and carried around for use in multiple computer systems. Although such use increases convenience, it brings with it many of the security and usability issues of confidential listings in hard-copy form. For example, if a portable storage device is lost or misplaced, the user is without important information. Additionally, storing the portable devices in a convenient and secure manner is difficult, if not impossible. Moreover, given their functional nature and scarcity, it has become commonplace to “borrow” such devices for routine file management operations, such as copying, moving, etc. While borrowing the devices, unauthorized users may access the data that the owner sought to maintain confidential. Thus, portable storage devices do not solve, and in some instances only exacerbate, the existing security issues surrounding computer systems.

### SUMMARY OF THE INVENTION

Accordingly, a need exists to reduce unauthorized access to computer systems. More specifically, a need exists to reduce unauthorized access to confidential information in hard-copy and soft-copy form used to gain access to computer systems. Additionally, a need exists to reduce the ability of an unauthorized user to interact with a computer system. Embodiments of the present invention provide novel solutions to these needs and others as described below.

Embodiments of the present invention are directed to an apparatus and system for improving computer system security. More specifically, embodiments provide convenient and effective mechanisms for securing items comprising confidential information with a locking mechanism, where the locking mechanism may also disable computer interfaces such that the ability of unauthorized users to interact with a computer system is reduced. In one embodiment, an apparatus for improving security includes a housing with a surface for use with a cursor positioning device for a computer system. The surface may form a mouse pad for use with a cursor positioning device (e.g., a computer mouse). The apparatus also includes a first member for placing a second object thereon, where the first member is operable for insertion into the housing. The first member may be a drawer which is slidably-coupled with the housing such that a second object (e.g., password lists, portable storage devices, etc.) may be placed within the drawer. A lock mechanism is coupled with the housing, where the lock mechanism is operable to place the first member in a secured state by limiting movement thereof, and where the secured state limits access to the second object. The lock mechanism may be mechanical (e.g., key-actuated, combination, etc.), electrical (e.g., voice activated, etc.), optical (e.g., fingerprint activated, use eye-related recognition, etc.), or the like. As such, the drawer may be slid into the housing such that objects placed therein may be secured when the lock mechanism is activated. The apparatus may also include a second member coupled to the housing for securing the apparatus to a third object (e.g., a desk, workspace, etc.).

Other embodiments of the present invention include the above, and wherein the lock mechanism is further coupled with a switch for disabling an interface of a coupled computer system. The interface may couple a computer system to a plurality of computer interfaces, such as wired and wireless peripheral devices (e.g., a computer mouse, keyboard, display, etc.). In this embodiment, when the lock mechanism is activated and the apparatus is placed in a secured state (e.g., the drawer is locked), the computer interface may also be disabled to limit unauthorized access to confidential information that would otherwise be accessible via the coupled peripheral devices and stored within (or accessible by) the coupled computer system.

Other embodiments of the present invention include the above, and wherein the apparatus is included within a computer system. Additionally, embodiments include the above, and wherein the apparatus is included within a peripheral device. Embodiments also include the above, wherein the apparatus is a computer system user interface device.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a block diagram of an exemplary system for increasing computing security in accordance with one embodiment of the present invention.

FIG. 2 shows a block diagram of an exemplary security device for increasing computing security in accordance with one embodiment of the present invention.

FIG. 3 shows a block diagram of an exemplary computer system in accordance with one embodiment of the present invention.

FIG. 4 shows a perspective view of an exemplary security device with a top cover in accordance with one embodiment of the present invention.

FIG. 5 shows a perspective view of an exemplary security device without a top cover in accordance with one embodiment of the present invention.

FIG. 6 shows a perspective view of an exemplary security device in a secured state with a wire-framed top cover in accordance with one embodiment of the present invention.

FIG. 7 shows a perspective view of an exemplary lock mechanism of a security device in accordance with one embodiment of the present invention.

FIG. 8 shows a perspective view of an exemplary keyboard with an incorporated security device in accordance with one embodiment of the present invention.

FIG. 9 shows a perspective view of an exemplary display with an incorporated security device in accordance with one embodiment of the present invention.

FIG. 10 shows a perspective view of an exemplary computer system chassis with an incorporated security device in accordance with one embodiment of the present invention.

FIG. 11 shows a perspective view of an exemplary trackball input device with an incorporated security device in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

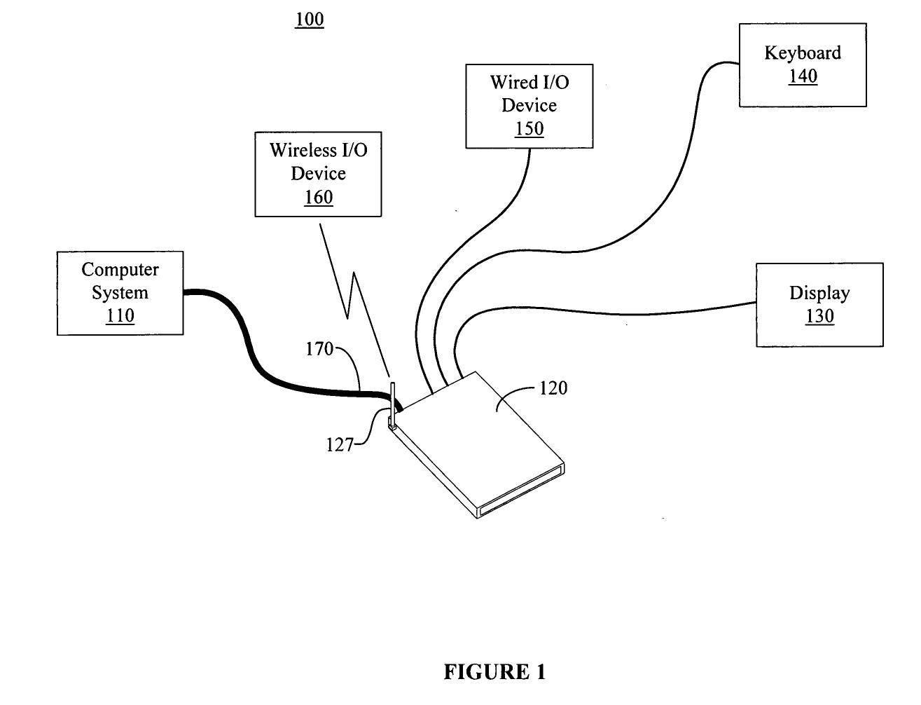

FIG. 1 shows a block diagram of exemplary system 100 for increasing computing security in accordance with one embodiment of the present invention. As shown in FIG. 1, computer system 110 is coupled to security device 120 via interface 170 for communicating with input/output (I/O) devices coupled thereto. For example, display 130, keyboard 140, wired I/O device 150 (e.g., wired computer mice, external storage devices, etc.) are shown coupled to device 120 for sending and receiving signals over wired interfaces, whereas wireless I/O device 160 (e.g., wireless computer mice, wireless external storage devices, etc.) is depicted as communicating wirelessly with device 120 via antenna 127. Alternatively, computer system 110 may communicate with device 120 via a wireless interface between an antenna (not shown) of computer system 110 and antenna 127 of device 120.

Given the positioning of device 120 in system 100 (e.g., between computer system 110 and a plurality of I/O devices), device 120 may effectively control access of coupled wired and wireless I/O devices to computer system 110. For example, the wireless interface coupling wireless I/O device 160 may be gated, switched, regulated, etc., thereby limiting access to computer system 110 via wireless I/O device 160. As such, when in a secured state, device 120 may reduce the ability of an unauthorized user to use, communicate with, and/or access information (e.g., stored within computer system 110, wired I/O device 150, wireless I/O device 160, etc.) or other functionality of computer system 110.

Alternatively, device 120 may regulate I/O interfaces to enforce privilege levels for accessing computer system 110, where a higher privilege level permits greater access to information and functionality of computer system 110. Thus, by switching and/or regulating wireless interfaces coupling wireless I/O devices to computer systems, device 120 effectively increases the security of the computer systems to protect confidential information stored within and/or accessible via the coupled computer systems.

Similarly, device 120 may gate, switch, regulate, etc. any wired interface coupling a wired I/O device (e.g., 150) to effectively limit unauthorized access. For example, the interfaces connecting display 130 and/or keyboard 140 to computer system 110 may be switched off during a secured state, thereby preventing users from inputting commands and/or viewing the results of those commands. Alternately, such interfaces may be regulated by device 120 to limit user interaction with computer system 110 (e.g., to establish user privilege levels, etc.). Thus, by switching and/or regulating wired interfaces coupling wired I/O devices to computer systems, device 120 effectively increases the security of the computer systems to protect confidential information stored within and/or accessible via the coupled computer systems.

Although computer system 110 is depicted in FIG. 1 as a desktop chassis, it should be appreciated that computer system 110 may alternatively be a laptop, personal digital assistant (PDA), cellular phone, embedded system, or the like. Additionally, device 120 may couple additional and/or different I/O devices from those depicted in FIG. 1. Further, although certain I/O devices are depicted as communicating via wired or wireless interfaces, it should be appreciated that the I/O devices may utilize alternative interfacing methods in other embodiments (e.g., keyboard 140 may be a wireless keyboard, etc.).

Although device 120 is depicted as a separate unit from computer system 110, it should be appreciated that device 120 may be integrated with computer system 110 in other embodiments. Similarly, although device 120 is depicted as a separate unit from display 130, keyboard 140, wired I/O device 150 and wireless I/O device 160, it should be appreciated that device 120 may be integrated with one or more of these I/O devices in other embodiments.

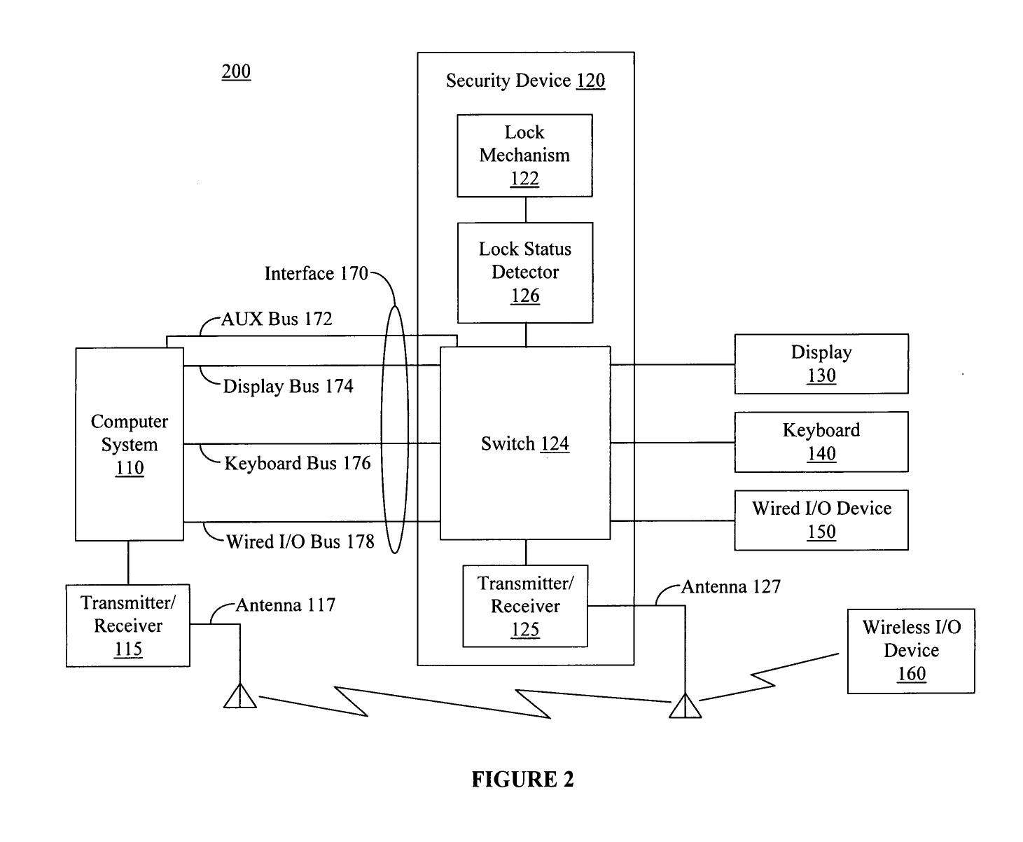

FIG. 2 shows block diagram 200 of an exemplary security device for increasing computing security in accordance with one embodiment of the present invention. As shown in FIG. 2, security device 120 is disposed between computer system 110 and a plurality of wired and wireless I/O devices (e.g., display 130, keyboard 140, wired I/O device 150 and wireless I/O device 160). As such, device 120 may effectively increase the security of computer system 110 by regulating access to confidential information stored within and/or accessible to computer system 110 (e.g., stored within computer system 110, wired I/O device 150, wireless I/O device 160, etc.) and/or other functionality of computer system 110.

Device 120 may switch and/or regulate wired and wireless interfaces coupled thereto using optional switch 124. Switch 124 may utilize mechanical switching (e.g., relays, etc.) and/or digital switching to control access to computer system 110, where the switching and/or regulation is controlled by processors, logic and other circuitry. As such, switch 124 may switch both analog and digital interfaces, where switching of interfaces is accomplished with acceptable characteristics (e.g., impedance mismatch, interface length within device 120 to dampen reflections, etc.) to maintain signal integrity.

As shown in FIG. 2, switch 124 receives a plurality of inputs and outputs from I/O devices. For example, display 130, keyboard 140 and wired I/O device couple to switch 124. Additionally, transmitter/receiver 125 is coupled to switch 124 for sending and receiving signals via antenna 127. As such, switch 124 may receive signals from wireless devices (e.g., 160) utilizing various signaling techniques (e.g., Bluetooth, IEEE 802.11a, IEEE 802.11b, IEEE 802.11g, CDMA, WCDMA, TDMA, 3G, LMDS, MMDS, etc.).

Switch 124 may route the signals from coupled I/O devices over one or more interfaces coupling device 120 to computer system 110. For example, interface 170 may couple device 120 and computer system 110. Alternatively, device 120 and computer system 110 may be coupled via a wireless interface using wireless components of device 120 (e.g. transmitter/receiver 125 and antenna 127) and computer system 110 (e.g., transmitter/receiver 115 and antenna 117). And in other embodiments, one or more wireless and/or wired interfaces may be used to couple device 120 to computer system 110, thereby enabling communication between device 120 and computer system 110 for sending data (e.g., similar to that transferred via the wired buses depicted in FIG. 2), status updates, presence detection, or some other communicative task.

As shown in FIG. 2, interface 170 may comprise a plurality of dedicated and/or shared buses. For example, display bus 174 may transmit analog and/or digital signaling for communication with display 130. Keyboard bus 176 may enable analog and/or digital communication with keyboard 140. Additionally, analog and/or digital communication with wired I/O device 150 may be transmitted via wired I/O bus 178. Instead of utilizing a dedicated bus for individual wired devices, or when it is desirable to route wireless inputs to device 120 over wired interfaces to computer system 110, AUX bus 172 may pass signals from one or more wired or wireless I/O devices to and from computer system 110. Alternatively, AUX bus 172 may enable communication (e.g., using signaling in accordance with USB 2.0, PCI-Express, etc.) between device 120 and computer system 110 for status updates, presence detection, or some other communicative task.

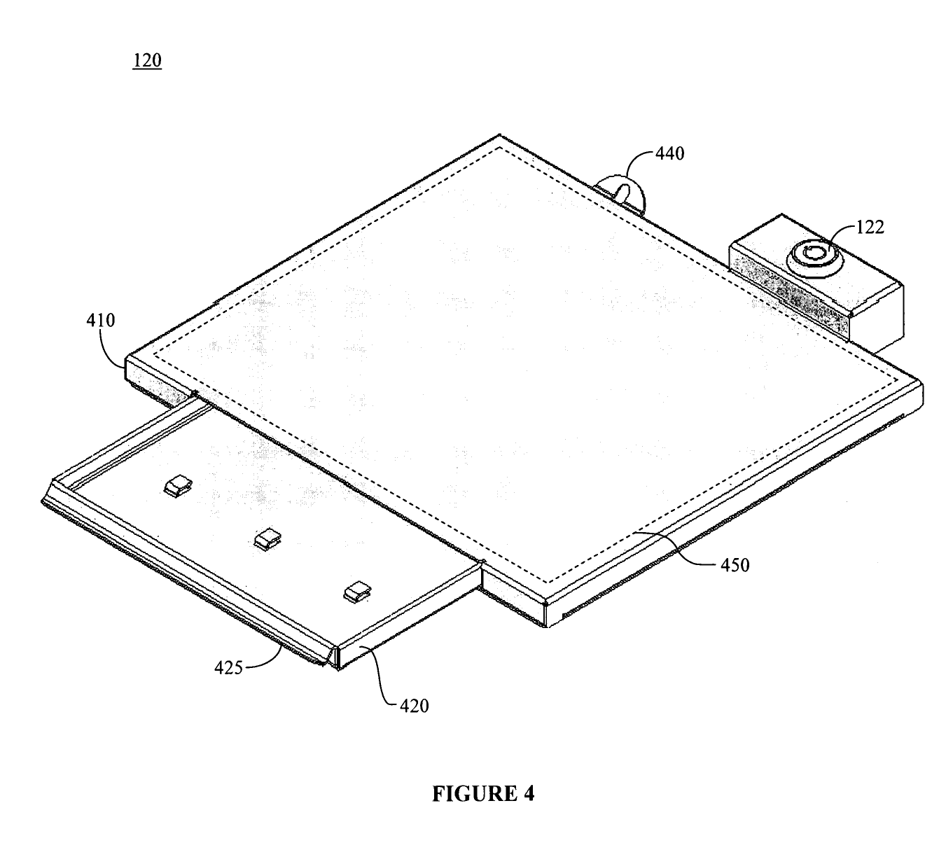

As more fully explained below with reference to FIGS. 4 through 10, device 120 includes mechanical lock mechanism 122 to secure items therein. As such, a user may place items comprising confidential information (e.g., password listings, username listings, portable storage devices containing confidential information and/or documents, etc.) into device 120 such that access to the items is limited when the lock mechanism is activated, thereby placing device 120 in a secured state. Lock mechanism 122 may comprise any known locking technology, where a user may toggle between one or more security states (e.g., corresponding to privilege levels) using a user interface associated with the locking mechanism. For example, the locking mechanism may be mechanical (e.g., key-actuated, combination, etc.), electrical (e.g., voice activated, etc.), optical (e.g., fingerprint activated, use eye-related recognition, etc.), or the like.

As shown in FIG. 2, lock status detector 126 couples to lock mechanism 122 and switch 124 such that switch 124 is updated when lock mechanism switches among security states. As such, detector 126 may access the lock status upon a change in state, and then relay this information to switch 124 to appropriately switch or regulate access to computer system 110. Although detector 126 is depicted as a separate component from lock mechanism 122 and switch 124, it should be appreciated that detector 126 may be integrated with either the lock mechanism or the switch. Moreover, where switch 124 is mechanical, it should be appreciated that detector 126 may be implemented as an element coupling the switch with the lock mechanism (e.g., a shaft, pulley system, etc.). As such, device 120 provides a convenient mechanism for securing items while simultaneously increasing the security of a coupled computer system by regulating access to confidential information accessible on or via the computer system.

Additionally, computer system 110 may include hardware and/or software capable of detecting the presence of device 120 to further increase the security of data stored within or accessible by computer system 110. The presence may be detected using one or more of the wired and/or wireless interfaces (e.g., 170, 172,174,176,178, between antennas 117 and 127, etc.) coupling device 120 and computer system 110. As such, when the presence of the device is detected, access to such data may be increased (e.g., user privileges increased, more data made accessible, applications unlocked, etc.). However, when the presence of device 120 is not detected, access to such data may be reduced (e.g., user privileges decreased, less data made accessible, applications locked, etc.).

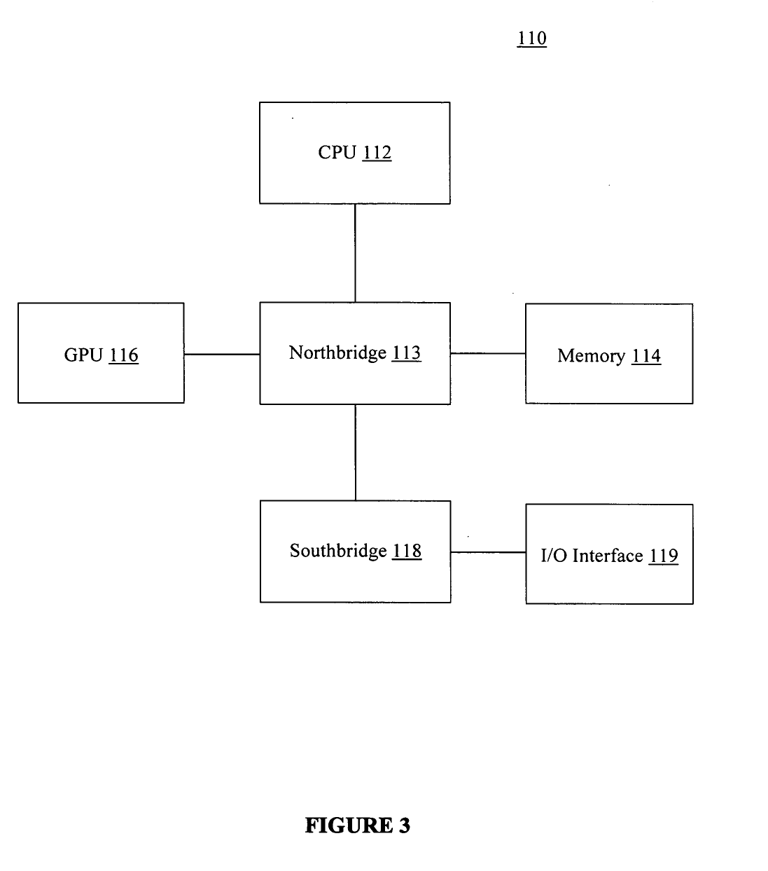

FIG. 3 shows a block diagram of exemplary computer system 110 in accordance with one embodiment of the present invention. As shown in FIG. 3, computer system comprises central processing unit (CPU) 112 for performing general processing operations (e.g., executing instructions, managing memory requests, etc.). Northbridge 113 is shown coupled to CPU 112 for managing access to memory 114, which may be detachably coupled to northbridge 113 (e.g., as a DIMM). Graphics processing unit (GPU) 116 is shown coupled to northbridge 113 for performing graphics processing operations, where GPU 116 may be detachably coupled with computer system 110 (e.g., as a component of a graphics card). Northbridge 113 couples to southbridge 118 such that components of computer system 110 may communicate with I/O devices via I/O interface 119, where I/O interface 119 is shown coupled to southbridge 118.

Although FIG. 3 depicts computer system 110 in a specific configuration, it should be appreciated that other computer systems may utilize different configurations. Moreover, computer system 100 may comprise more or less components depending upon the application. However, regardless of the configuration, computer system 110 should comprise a plurality of I/O interfaces (e.g., 119) for communication with other systems and devices (e.g., 120). The interfaces may be either wired or wireless, or both. As such, device 120 may protect confidential information stored within various components of computer system 110 (e.g., memory 114, registers of CPU 112, registers of northbridge 113, registers of southbridge 118, etc.) and/or within other memory devices coupled to computer system 110 (e.g., 150 and/or 160) by limiting access to computer system 110, and more specifically, to I/O interface 119.

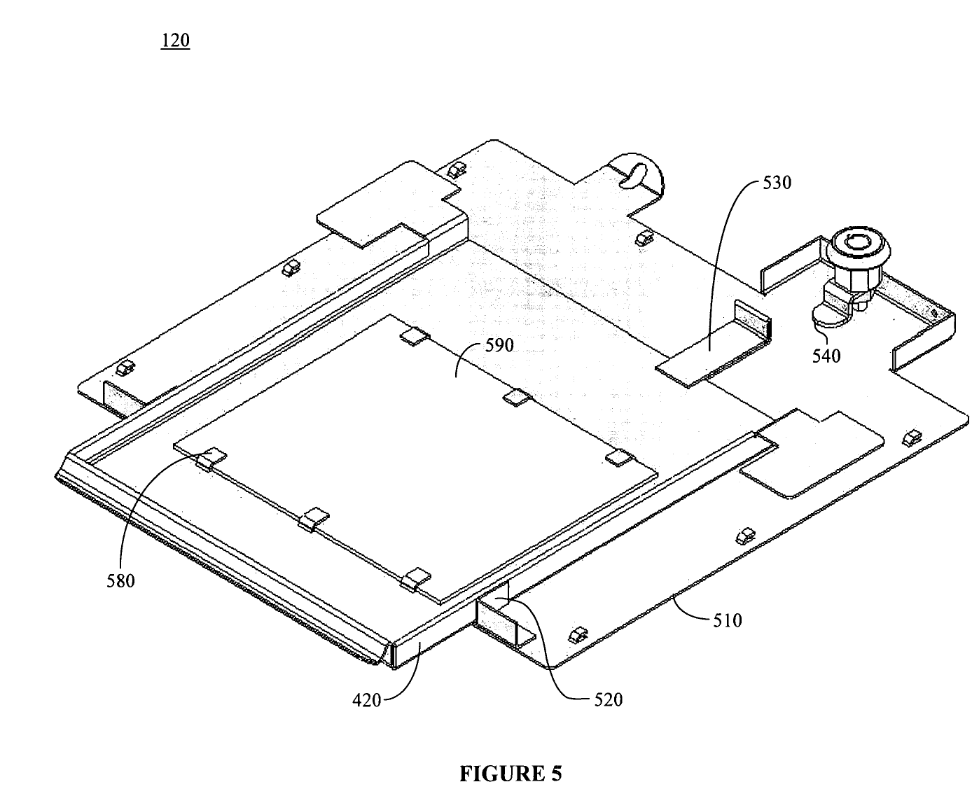

Now turning to FIGS. 4 and 5, FIG. 4 shows a perspective view of exemplary security device 120 with top cover 410 in accordance with one embodiment of the present invention, while FIG. 5 shows a perspective view of exemplary security device 120 without top cover 410 in accordance with one embodiment of the present invention. The housing of device 120 comprises top cover 410 disposed above base 510. Top cover 410 has a cutout sufficient to accommodate drawer 420, where drawer 420 may slide outward from device 120 such that objects may be placed within drawer 420 (e.g., item 590). When drawer 420 is slid into device 120, the state of lock mechanism 122 may be adjusted (e.g., by turning a key, etc.) such that lock arm 540 (shown coupled to lock mechanism 122) engages locking feature 530 (shown coupled to drawer 420).

Although FIGS. 4 and 5 depict lock mechanism 122 as a key-actuated lock, it should be appreciated that lock mechanism may be implemented in alternative fashions in other embodiments. For example, as discussed above with respect to FIG. 2, lock mechanism 122 may be mechanical (e.g., key-actuated, combination, etc.), electrical (e.g., voice activated, etc.), optical (e.g., fingerprint activated, use eye-related recognition, etc.), or the like. As such, once the state of the lock mechanism is changed (e.g., into a secured state), drawer 420 should be restrained within the housing such that items placed therein are secured. Although lock arm 540 and locking feature 530 may be implemented as depicted in FIG. 5, it should be appreciated that the drawer may be alternatively restrained in other embodiments.

Although not shown in FIGS. 4 and 5, device 120 may include provisions for routing of interfaces (e.g., 170) for coupling computer systems and I/O devices as described above with respect to FIGS. 1 and 2. As such, device 120 may include a plurality of ports, where the ports are coupled to a switch (e.g., 124). Cables may then be inserted into the ports for coupling computer systems and I/O devices. Alternatively, the interfaces could be plumbed directly into device 120 without ports (e.g., with cables), such that the interfaces could couple directly to the switch. The other end of the interface may then be coupled to computer systems and I/O devices. The switch may then be coupled with the lock mechanism (e.g., via detector 126) for automatic adjustment of the state of the switch in relation to the state of the lock mechanism (e.g., adjusted via user interaction).

Once in a secured state, access to items placed within drawer 420 is limited (e.g., concealed by top cover 410). As such, device 120 offers users a convenient mechanism to secure items within device 120 when leaving them unattended. Moreover, device 120 includes anchoring mechanism 440 for securing device 120 to a less-portable object (e.g., a desk, workstation, etc.). Although anchoring mechanism 440 is depicted in FIG. 5 as integrated with base 510, it may be attached to other portions of device 120 (e.g., top cover 410). Additionally, anchoring mechanism 440 may be detachably coupled to device 120, thereby allowing users to customize device 120 while still providing security (e.g., by preventing the anchoring mechanism from being detached from the outside of device 120). Thus, anchoring mechanism 440 provides additional security for items secured within device 120.

As shown in FIGS. 4 and 5, drawer handle 425 is coupled to a portion of drawer 420 such that a user may access the handle to slide drawer 420 from device 120. A plurality of front drawer guides 520 may be coupled to base 510 to guide drawer 420 when sliding it with respect to base 510 and top cover 410. Although guides 520 are depicted as flat members, it should be appreciated that they may be implemented using other shaped (e.g., round pegs, etc.) in other embodiments. Alternatively, the guides may be coupled to the drawer such that they track features in the base. Alternatively, the guides may be coupled to or integrated into the top cover.

Upon sliding the drawer out from device 120, items may be placed within drawer 420. For example, item 590 may be a listing of passwords and/or usernames, where item 590 is held down and organized by a plurality of item organizing features 580 (e.g., tabs coupled to drawer 420). Although not shown in FIGS. 4 and 5, item organizing features may assume other shapes and/or configurations. For example, the features may be clips, which may be formed from one member (e.g., using a material with spring-like properties) or more than one member. In a multi-member clip, at least one member may be a spring to provide clamping force for securing items within drawer 420. Additionally, vertical dividers may be used to prevent items (e.g., portable storage devices, writing instruments, etc.) from shifting during storage. Moreover, a combination of multiple types of features may be used to store and hold down items of different shapes and sizes.

As shown in FIGS. 4, the height of device 120 is substantially smaller than its length and width, such that top cover 410 forms surface 450 (as denoted by the dashed lines). Surface 450 is substantially flat such that peripheral devices (e.g., a computer mouse, other cursor directing devices, etc.) can be moved across the surface. As such, it should be appreciated that surface 450 may be coated such that the peripheral device (e.g., optical mice, laser mice, etc.) is able to track its movement across surface 450. Similarly, it should be appreciated that an additional object (e.g., a rubber pad) may be placed on top of surface 450 to further customize the surface for interface with peripheral devices. Additionally, the peripheral devices may also be coupled with a switch of device 120 (e.g., 124) such that a user may conveniently limit access of an unauthorized user to a coupled computer system via the peripheral device as discussed above with respect to FIGS. 1 and 2.

Although device 120 is depicted in FIGS. 4 and 5 with a height substantially smaller than its length and width, it should be appreciated that the height is sufficient to allow the placement of objects into drawer 420 and the closing of drawer 420 such that the objects may be secured within device 120. In other embodiments, the height of device 120 and/or drawer 420 may be varied to allow the securing of larger objects. Additionally, top cover 410, base 510 and/or drawer 420 may be modified to accommodate larger objects such that drawer 420 protrudes outside top cover 410 and/or base 510.

Furthermore, device 120 may be formed from a variety of materials to provide varying costs, levels of security, and design choices. For example, the housing of device 120 may be formed from sheet metal. Alternatively, an impact resistant plastic (e.g., polycarbonate, acrylonitrile butadiene styrene, a PC/ABS combination, etc.) may be used. Moreover, the material may be colored (e.g., by the use of colored material, colored coating, etc.), where such color scheme may coordinate and/or match that of a coupled device or system (e.g., 110, 130,140, 150,160, etc.).

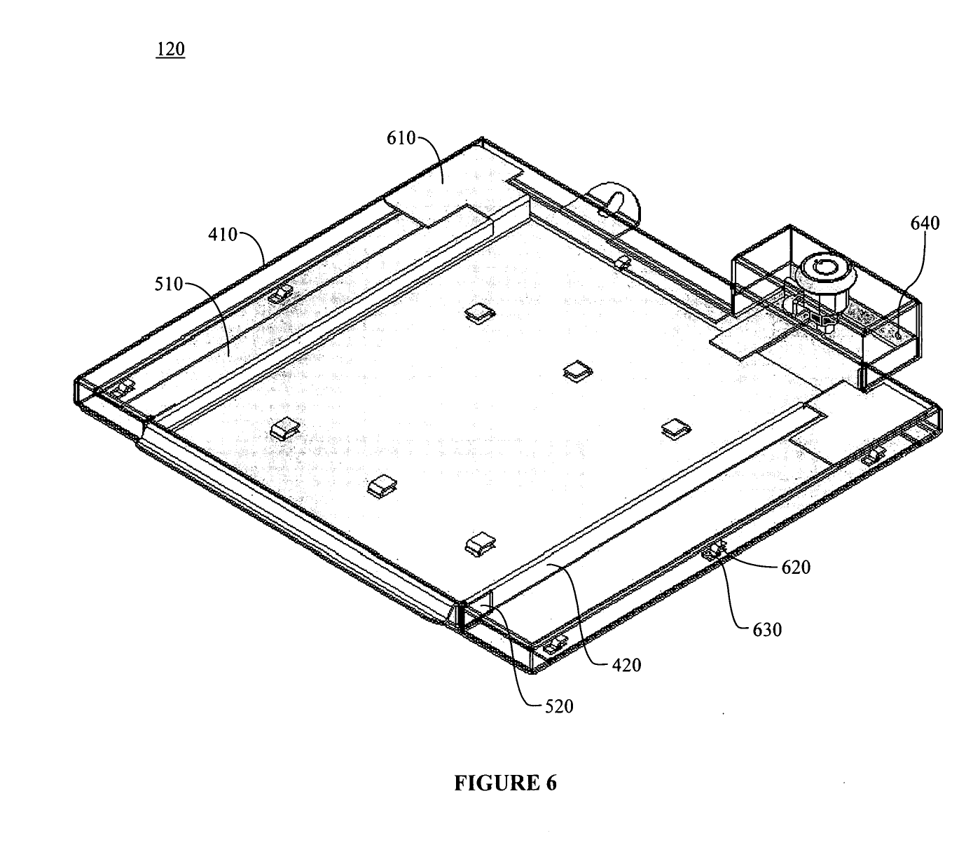

FIG. 6 shows a perspective view of exemplary security device 120 in a secured state with a wire-framed top cover in accordance with one embodiment of the present invention. As shown in FIG. 6, top cover 410 (shown as a wire-frame) is coupled to base 510 via top cover hold-down features 620. Features 620 engage hold-down feature engagement slots 630, where slots 630 are integrated into top cover 410. After engaging the features and slots, top cover 410 may be fastened to base 510 by aligning top cover fastening points 640 integrated into base 510 with corresponding features in the top cover. Once aligned, a fastener (e.g., rivet, screw, etc.) may be inserted and set to fasten the top cover to the base.

Although a specific manner of engaging and fastening the top cover and base are depicted in FIG. 6, it should be appreciated that other means may be used. For example, the top cover and base may snap together with locking features (e.g., snaps, tabs, etc.) and corresponding receptacle features. Alternatively, other coupling mechanisms (e.g., hinges, tabs, etc.) may be used in conjunction with locking features to minimize the number of fastening features. And in other embodiments, other secondary operations (e.g., heat staking, ultrasonic welding, etc.) may be performed to secure the top cover and base to one another.

As shown in FIG. 6, drawer 420 utilizes both front drawer guides 520 and rear drawer guides 610 to restrain movement to a substantially straight path when sliding the drawer with respect to top cover 410 and base 510. Guides 520 are integrated within top cover 410, while guides 610 are coupled to drawer 420. As such, guides 610 may track the inside wall of top cover 410 to guide the drawer.

Although specific front and rear drawer guide implementations are depicted in FIG. 6, it should be appreciated that other guides may be used. For example, front drawer guides 520 may be implemented as discussed above with respect to FIG. 5. Additionally, rear drawer guides 610 may be implemented similarly to the front drawer guides (e.g., alternatively coupled to the top cover, base, etc. as discussed above with respect to guides 520 in FIG. 5).

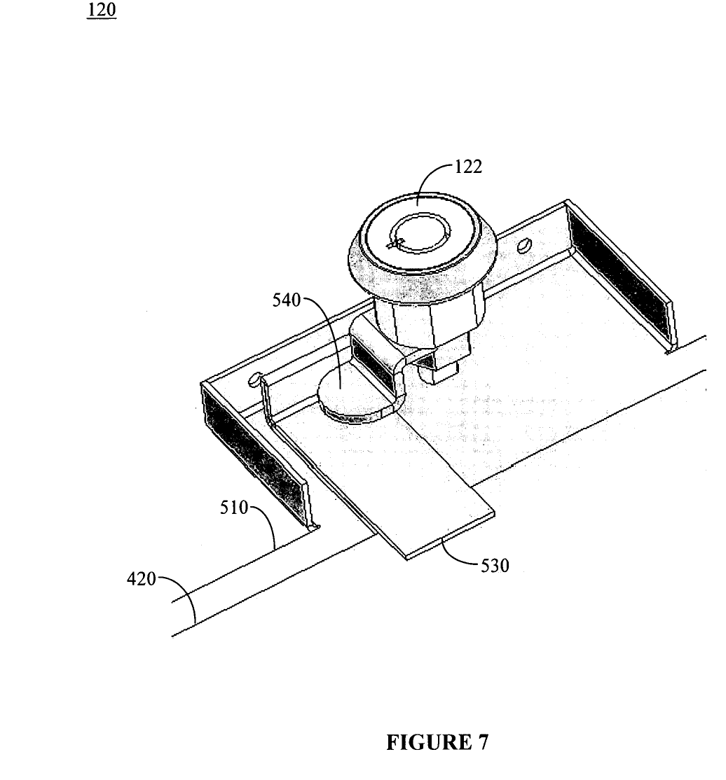

FIG. 7 shows a perspective view of an exemplary lock mechanism of security device 120 in accordance with one embodiment of the present invention. As shown in FIG. 7, lock arm 540 engages locking feature 530 coupled to drawer 420 when device 120 is placed in a secure state (e.g., by actuating lock mechanism 122). As such, lock arm 540 limits movement of drawer 420 with respect to base 510 such that items placed within drawer 420 are secured, where top cover 410 may limit access to the items. Furthermore, it should be appreciated that lock mechanism 122 is merely one example of many mechanisms that may be implemented within device 120 in other embodiments of the present invention as discussed above with respect to FIGS. 4 and 5.

Turning back to FIG. 6, guides 520 and 610 may work in conjunction to control the positioning of locking features of the drawer (e.g., 530) with respect to components of the lock mechanism that engage the drawer when in a secured state (e.g., lock arm 540). Locking feature 530 is thereby prevented from bypassing lock arm 540 such that drawer 420 may be opened when in a secured state. Thus, embodiments provide a convenient and effective means of securing items by limiting access thereto when device 120 is placed in a secured state.

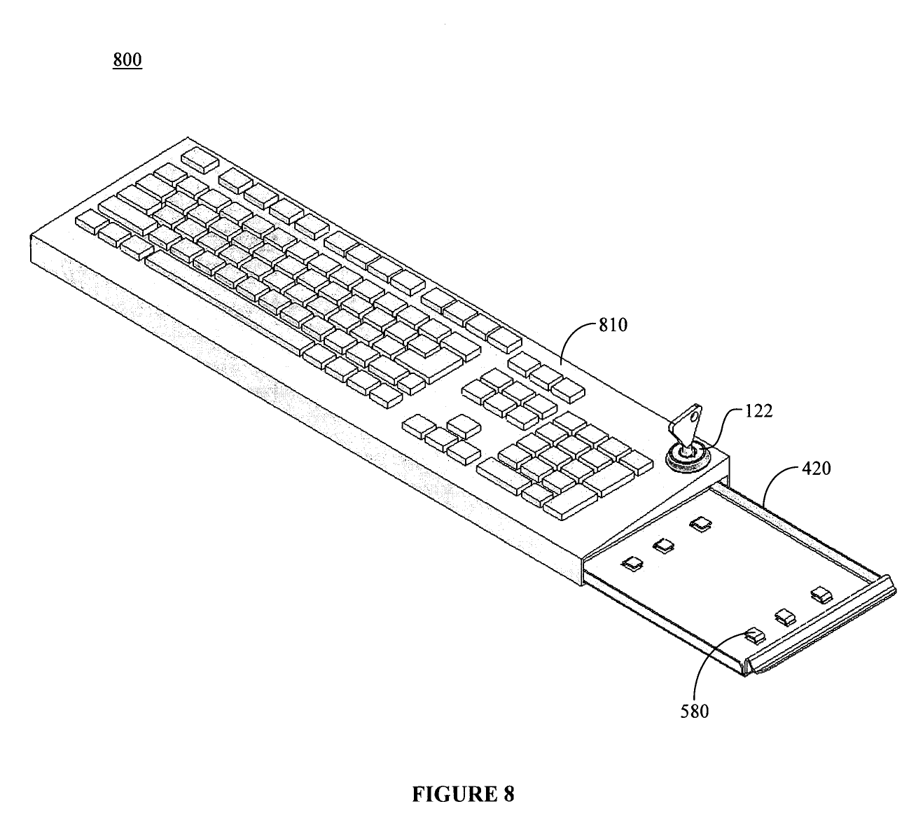

FIG. 8 shows a perspective view of exemplary keyboard 800 with an incorporated security device in accordance with one embodiment of the present invention. As shown in FIG. 8, keyboard 800 comprises housing 810 with a plurality of keys for generating signals sent to a computer system (e.g., 110) over a coupled interface (not shown). Drawer 420 is slidably-coupled with housing 810 such that items (e.g., password listings, portable storage devices, etc.) placed within the drawer and organized by item organizing features 580 may be secured when drawer 420 is positioned in a secured state. As such, security device 120 discussed above is effectively incorporated within keyboard 800.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to keyboard 800 (e.g, via the routing of cables into housing 810, mounting connectors on housing 810, etc.) such that keyboard 800 is positioned between the computer system and a plurality of I/O devices (e.g., wired and/or wireless). Thus, keyboard 800 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within keyboard 800, device 120 may be coupled to housing 810 (e.g., as an extension to housing 810). As such, embodiments provide a keyboard and a mouse pad (e.g., surface 450) for coupling to a computer system with similar security mechanisms as described above. Alternatively, device 120 may be detachably coupled to housing 810 (e.g., to provide a mouse pad, security device, etc.), thereby allowing a user to control the placement of the device with respect to the keyboard for added convenience.

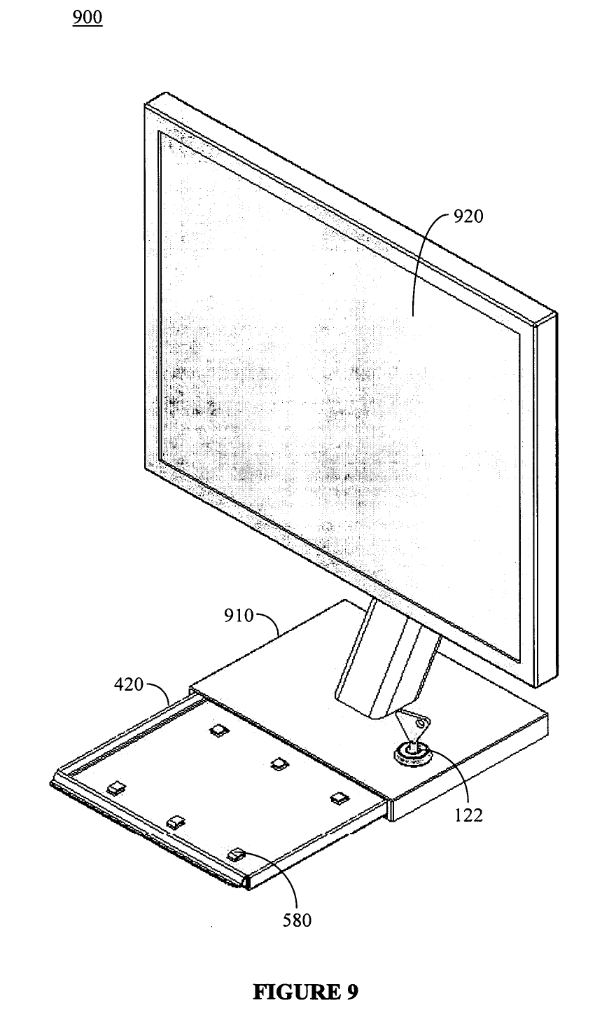

FIG. 9 shows a perspective view of exemplary display 900 with an incorporated security device in accordance with one embodiment of the present invention. As shown in FIG. 9, display 900 comprises housing 910 which supports display panel 920 for displaying computer generated signals communicated over an interface (not shown) coupling display 900 with a computer system (e.g., 110). Drawer 420 is slidably-coupled with housing 910 such that items (e.g., password listings, portable storage devices, etc.) placed within the drawer and organized by item organizing features 580 may be secured when drawer 420 is positioned in a secured state. As such, security device 120 discussed above is effectively incorporated within display 900.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to display 900 (e.g., via the routing of cables into housing 910, mounting connectors on housing 910, etc.) such that display 900 is positioned between the computer system and a plurality of I/O devices (e.g., wired and/or wireless). Thus, display 900 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within housing 910, device 120 may be coupled to display panel 920 (e.g., disposed behind panel 920). Alternatively, device 120 may be detachably coupled to housing 910 (e.g., to provide a mouse pad, security device, etc.), thereby allowing a user to control the placement of the device with respect to the display for added convenience.

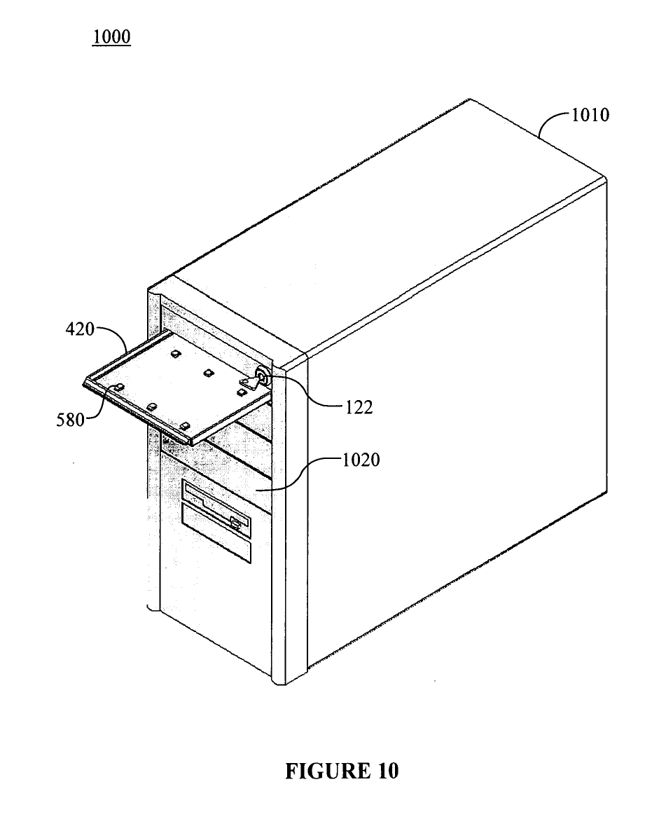

FIG. 10 shows a perspective view of exemplary computer system chassis 1000 with an incorporated security device in accordance with one embodiment of the present invention. As shown in FIG. 10, chassis 1000 comprises housing 1010 for mounting components of a computer system (e.g., 110 of FIGS. 1, 2 and/or 3), where the assembled computer system may include one or more interfaces (not shown) for communicating with coupled I/O devices. Drawer 420 is slidably-coupled with housing 1010 such that items (e.g.,

Patent password listings, portable storage devices, etc.) placed within the drawer and organized by item organizing features 580 may be secured when drawer 420 is positioned in a secured state. As such, security device 120 discussed above is effectively incorporated within chassis 1000.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to the computer system (e.g., 110) via one or more interfaces coupling I/O devices to the switch. As such, computer interfaces may be coupled to chassis 1000 (e.g, via the routing of cables into housing 1010, mounting connectors on housing 1010, etc.) such that the switch is positioned between components of the computer system capable of accessing confidential information and a plurality of I/O devices (e.g., wired and/or wireless). Thus, chassis 1000 may provide users a convenient and effective mechanism to limit unauthorized access to confidential information stored within or accessible via the computer system.

In another embodiment, security mechanisms of the present invention may be alternatively implemented to provide additional functionality and flexibility. For example, instead of integrating device 120 within a dedicated region of housing 1010, device 120 may be implemented within any drive bay 1020 of chassis 1000 (e.g., fixedly coupled, removably coupled, etc.). The drive bays may conventionally be used to house storage devices (e.g., hard disk drives, CD-ROM drives, DVD-ROM drives, etc.), I/O connector panels, heat intake/exhaust vents, etc. As such, device 120 may exclusively occupy a drive bay of chassis 1000, or alternatively share a drive bay with one or more components of the computer system. Alternatively, device 120 may be detachably coupled to housing 1010 (e.g., to provide a mouse pad, security device, etc.), thereby allowing a user to control the placement of the device with respect to the chassis for added convenience.

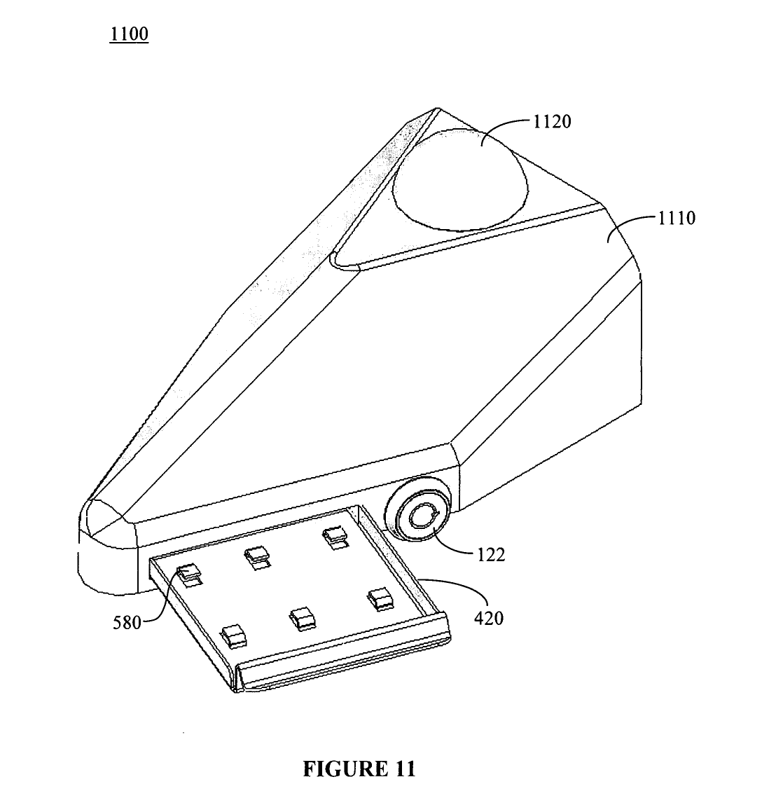

FIG. 11 shows a perspective view of exemplary trackball input device 1100 with an incorporated security device in accordance with one embodiment of the present invention. As shown in FIG. 11, input device 1100 comprises housing 1110 with integrated trackball 1120 for generating signals sent to a computer system (e.g., 110) over a coupled interface (not shown). Drawer 420 is slidably-coupled with housing 810 such that items (e.g., password listings, portable storage devices, etc.) placed within the drawer and organized by item organizing features 580 may be secured when drawer 420 is positioned in a secured state. As such, security device 120 discussed above is effectively incorporated within input device 1100.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to input device 1100 (e.g, via the routing of cables into housing 1110, mounting connectors on housing 1110, etc.) such that input device 1100 is positioned between the computer system and a plurality of other I/O devices (e.g., wired and/or wireless). Thus, input device 1100 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within input device 1100, device 120 may be coupled to housing 1110 (e.g., as an extension to housing 1110). As such, embodiments may provide an input device and a mouse pad (e.g., surface 450) for coupling to a computer system with similar security mechanisms as described above. Alternatively, device 120 may be detachably coupled to housing 1110 (e.g., to provide a mouse pad, security device, etc.), thereby allowing a user to control the placement of the device with respect to the input device for added convenience.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An apparatus for improving security, said apparatus comprising:
a housing with a surface for use with a cursor positioning device for a computer system;
a first member for placing a second object thereon, said first member operable for insertion into said housing;
a lock mechanism coupled with said housing, wherein said lock mechanism is operable to place said first member in a secured state by limiting movement thereof, and wherein said secured state limits access to said second object; and
a second member coupled to said housing for securing said apparatus to a third object.

2. The apparatus of claim 1, wherein said first member comprises a drawer, wherein said drawer is slidably-coupled with said housing.

3. The apparatus of claim 1, wherein said cursor positioning device is a computer mouse, and wherein said surface is operable to have said computer mouse disposed across thereof.

4. The apparatus of claim 1, wherein said lock mechanism is further coupled with a switch for disabling a computer interface when said first member is placed in said secured state.

5. The apparatus of claim 4, wherein said computer interface comprises wireless communication.

6. The apparatus of claim 4, wherein said computer interface comprises an input device for a computer system.

7. The apparatus of claim 4, wherein said computer interface comprises an output device for a computer system.

8. The apparatus of claim 7, wherein said output device is a computer display.

9. The apparatus of claim 1, wherein said second object comprises a listing of secure information.

10. The apparatus of claim 1, wherein said second object is a removable storage device.

11. A computer system for improving security, said system comprising:
a processor;
a memory coupled to said processor;
an interface coupled to said processor; and
a safe comprising:
a housing;
a member for placing a first object thereon, said member operable for insertion into said housing, and said first object comprising a listing of secure information;
a lock mechanism coupled with said housing, wherein said lock mechanism is operable to place said member in a secured state by limiting movement thereof, wherein said secured state limits access to said first object, and wherein said lock mechanism is further coupled to a switch for disabling said interface when said member is placed in said secured state.

12. The system of claim 11, wherein said member comprises a drawer, wherein said drawer is slidably-coupled with said housing.

13. The system of claim 11, wherein said interface comprises wireless communication.

14. The system of claim 11, wherein said interface comprises an input device for said computer system.

15. The system of claim 11, wherein said interface comprises an output device for said computer system.

16. The system of claim 11, wherein said member is operable to receive a second object, and wherein said secured state limits access to said second object.

17. The system of claim 16, wherein said second object is a removable storage device.

18. A peripheral device for improving security, said device comprising:
a housing;
a member for placing a first object thereon, said member operable for insertion into said housing, and said first object comprising a listing of secure information;
a first interface for coupling to a computer system;
a lock mechanism coupled with said housing, wherein said lock mechanism is operable to place said member in a secured state by limiting movement thereof, wherein said secured state limits access to said first object, and wherein said lock mechanism is further coupled to a switch for disabling said first interface when said member is placed in said secured state.

19. The device of claim 18, wherein said member comprises a drawer, wherein said drawer is slidably-coupled with said housing.

20. The device of claim 18, wherein said first interface comprises wireless communication.

21. The device of claim 18 further comprising a second interface operable to couple a second peripheral device to said computer system, wherein said switch is further operable to disable said second interface when said member is placed in said secured state.

22. The device of claim 21, wherein said second peripheral device is a computer display.

23. A computer system user interface device comprising:
a housing comprising a substantially flat surface for use as a pad for a cursor directing device of said computer system;
a drawer for sliding into said housing, said drawer comprising a cavity for storage of an item therein; and
a locking mechanism operable to engage said drawer with said housing and limit access to said item when locked, wherein said locking mechanism is coupled to said housing.

24. The device of claim 23, wherein said item is a paper bearing passwords.

25. The device of claim 23, wherein said housing further comprises an attachment for use in securing said housing to a workspace.

26. The device of claim 23, wherein a height of said housing is substantially smaller than a length and width of-said housing, and wherein said drawer comprises a plurality of features for removably securing said item to said drawer.

27. The device of claim 23 further comprising a computer interface, and further wherein said locking mechanism gates operation of said computer interface.
